(19) United States
(12) Patent Application Publication
(10) Pub. No.: US 2008/0109722 A1
(43) Pub. Date: May 8, 2008

(54) DIRECT PRESENTATION OF HELP INFORMATION RELATIVE TO SELECTABLE MENU ITEMS IN A COMPUTER CONTROLLED DISPLAY INTERFACE

(76) Inventors: WILLIAM H. GENGLER, Austin, TX (US); Mark D. Rogalski, Leander, TX (US)

Correspondence Address: IBM CORPORATION;INTELLECTUAL PROPERTY LAW, 11400 BURNET ROAD, AUSTIN, TX, 78758, US

(21) Appl. No.: 11/556,856

(22) Filed: Nov. 6, 2006

(51) Int. Cl. G06F 3/00

(52) U.S. Cl. 715/708

(57) ABSTRACT

A GUI interface on a computer display where contextual help on menu item is accessible, and displayable immediately adjacent menu item on which help is sought. A user is enabled to select a menu item for help data. An implementation links each of the plurality of menu items to a respective source of contextual help data, and displays the resulting contextual help data for the selected menu item, in a box or bubble adjacent to the menu item. For situations in which a menu item may be disabled the help box will set forth why the menu item is disabled, and how the user may enable the menu item and the function represented by it.

### TECHNICAL FIELD

The present invention relates to user interactive computer supported display technology and particularly to Graphical User Interfaces (GUIs) that are user-friendly and provide interactive users with an interface environment that is easy to use.

### BACKGROUND OF RELATED ART

The past generation has been marked by a technological revolution driven by the convergence of the data processing industry with the consumer electronics industry. This advance has been even further accelerated by the extensive consumer and business involvement in the Internet or World Wide Web (Web). As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent.

In order for the vast computer supported industries and market places to continue to thrive, it will be necessary for increasing numbers of workers and consumers who are limited in computer skills to become involved with computer interfaces. An interface function which has caused considerable confusion and discomfort to GUI interface users have been implementations which prompt the interactive user choices through menus of selectable items. Menu items are often short cryptic names or icons that do not adequately inform the user about the computer or program function represented by the item. Thus, the user is required to access the “Help” functions in the computer system to get more information on the menu item. Help functions are often obscure, and remote from the user. The user is required to go through several layers of interfaces in order to reach appropriate help. Getting help for context menus is even more difficult. For example, if the user is running an application program, it may be difficult for a user to determine whether the menu item of interest is from the computer operating system or from a menu in the application program. The situation is sometimes complicated through the use of a string of cascaded menus i.e. each sequential menu is activated and thereby inherited from a selection in a previous menu. This makes it even more difficult to determine the source from which conventional help may be sought.

In addition, menu items are frequently “grayed-out” to indicate that they are inactive i.e. they can not chosen in the context where the menu is being presented. In such situations, help is needed so that the user may determine why the menu item is not available for selection, and how the user may make the menu item available for selection.

It is recognized that various forms of context-sensitive help has been made available to users. However, even such contextual help still requires the user to independently access help, and then try to reconcile the menu term with a variety of functions on which help is offered.

### SUMMARY OF THE PRESENT INVENTION

The present invention offers a user friendly computer controlled display interface for an operating computer in which direct contextual help on a menu item is accessible, and displayable immediately adjacent menu item on which help is sought. Thus, the invention comprises a combination of means for displaying a menu of a plurality of selectable items, each representative of a system function and means enabling a user to select a menu item to perform the represented function. To this combination, the invention provides means enabling a user to select a menu item for help data for the selected item, means linking each of the plurality of menu items to a source of contextual help data for each of the menu items, and means, responsive to the means enabling a user to select, for displaying the resulting contextual help data for the selected menu item.

This combination is operative whether the help information source is in the operating system or in any application program running on the computer. The menu items may be textual or icons. The present invention is also operable to deal with situations in which a menu item may be disabled in a given menu environment. In such a case, the help box adjacent the menu item will set forth why the menu item is disabled, and how the user may enable the menu item and the function represented by it.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic view of a display screen illustrating an initial stage where the interactive user has brought down a menu;

FIG. 2 is the view of FIG. 1 at a later stage when the user has selected a menu item for help;

FIG. 3 is the view of FIG. 1 at a later stage when the user has selected another menu item for help;

FIG. 4 is a variation of the display screen of FIG. 1 at a later stage when the user has selected an item from the tool bar menu for help;

FIG. 5 is a variation of the display screen of FIG. 1 the user has selected a disabled (grayed-out) item from the tool bar menu for help;

FIG. 6 is a block diagram of an interactive data processor controlled display system including a central processing unit that is capable of implementing the presentation of menu item related help data in accordance with the present invention;

FIG. 7 is a flowchart of the program steps involved in setting up a process of the present invention for implementing the presentation of menu item related help data;

FIG. 8 is a flowchart of the steps involved in an illustrative run of the process set up in FIG. 7.

### DETAILED DESCRIPTION OF THE PREFERRED EMBODIMENT

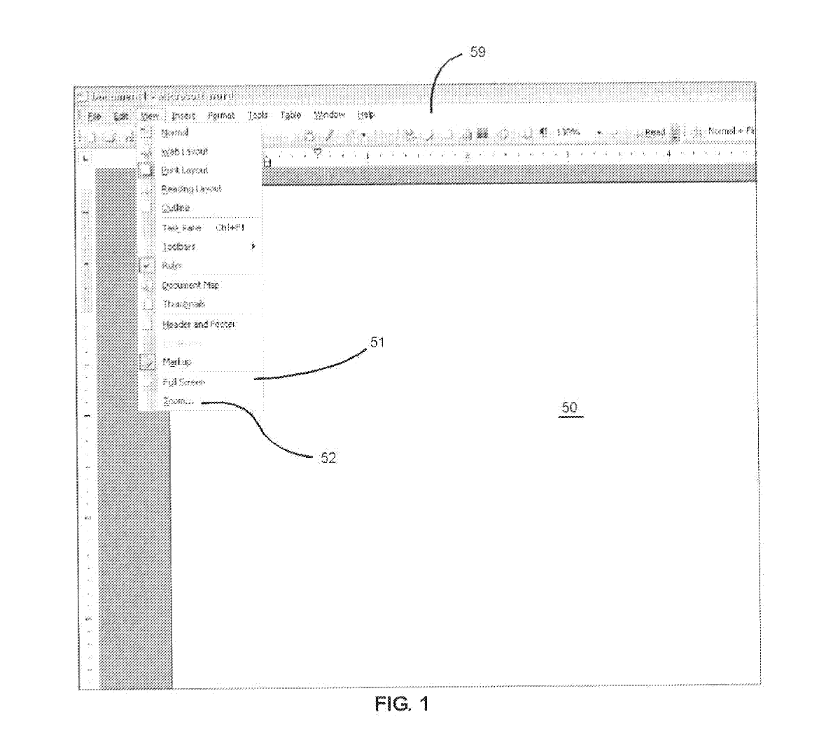

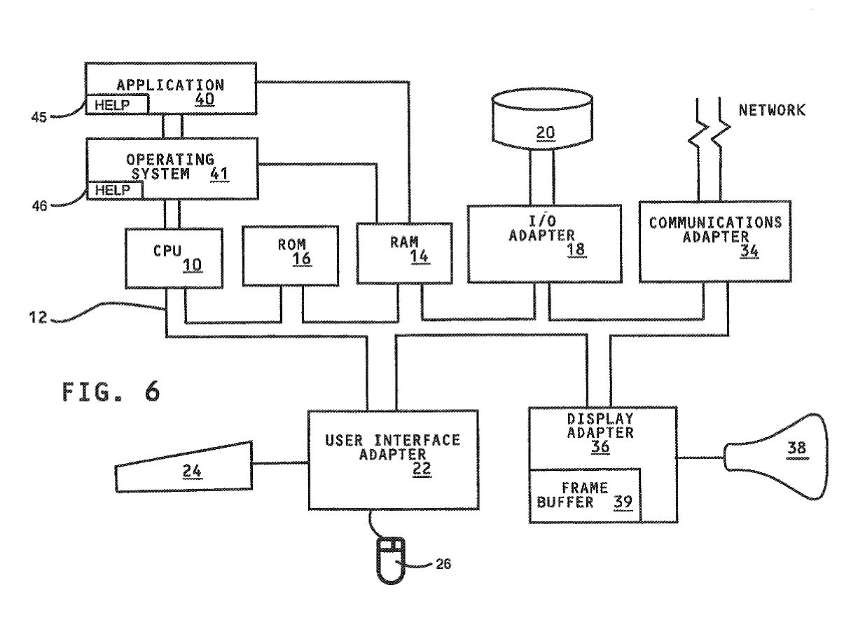

There will now be described a simplified illustration of the present invention with respect to the display screens of FIGS. 1 through 5. When the screen images are described, it will be understood that these may be rendered by storing image and text creation programs, such as those in any conventional window operating system in the RAM 14 of the system of the system of the present invention to be hereinafter described in greater detail with respect to FIG. 6. The controlling operating system is diagrammatically shown in FIG. 6 as operating system 41. The display screens of FIGS. 1 through 5 are presented to the viewer on display monitor 38 of FIG. 6. In accordance with conventional techniques, the user may control the screen interactively through a conventional I/O device, such as mouse 26 of FIG. 6, which operates through user interface 22 to call upon programs in RAM 14 cooperating with the operating system 41 to create the images in frame buffer 39 of display adapter 36 to control the display on monitor 38.

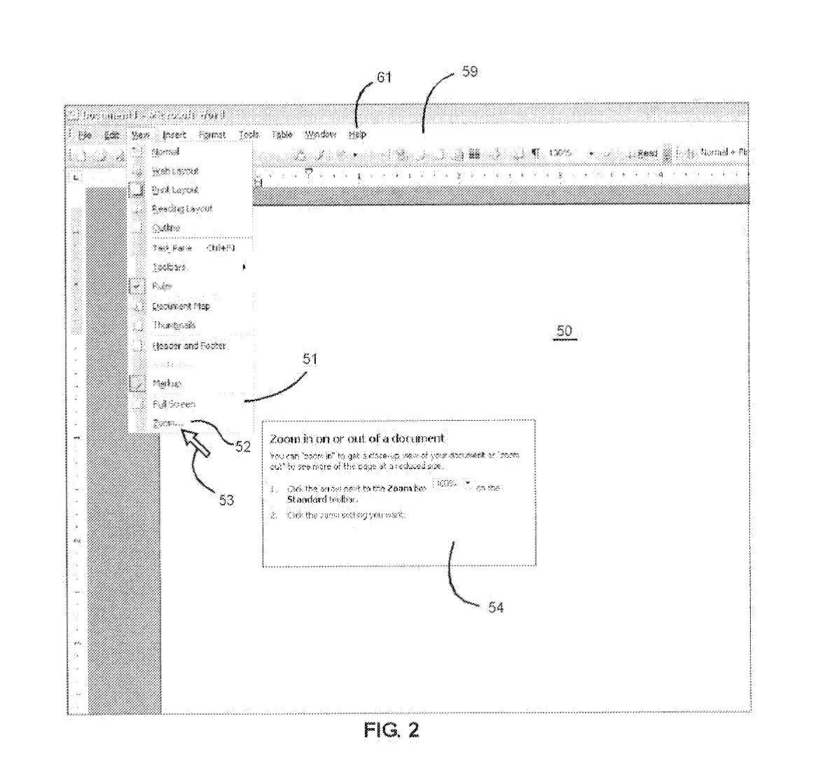

With reference to the display screen of FIG. 1, there is shown a simplified illustration of an initial display screen 50. Let us assume that the user is running an application program, and has dropped down a menu 51 from a selection “View” on the tool bar 59. The user is interested in perhaps using the “Zoom” item 52 on the menu, FIG. 2. He needs Help in understanding the Zoom item. The user moves his cursor 53 to Zoom item 52, and by an appropriate clicking of his mouse, e.g. double right click, brings up help window 54 immediately adjacent to the menu 51. Help window 54 will have the help data function which the program of this invention determines to be closest in terminology to the menu item Zoom 52. The help data in window 54 is generated, will be subsequently described in detail, by first determining whether the help for the selected menu item is presented from the operating system or an application running on the operating system. Once this is determined, system automatically goes to conventional look-up tables in the appropriate help database, and tracks the requested term “Zoom” to find the closest terms in the Help database much the same as would be searched for if the user had selected the Help item 61 on tool bar 59 to generate the help data shown in window 54. The help window 54 gives the user a start from which the user may proceed through a Help data hierarchy in any conventional manner through the selection of appropriate links in the Help window 54 or sequences of links therefrom.

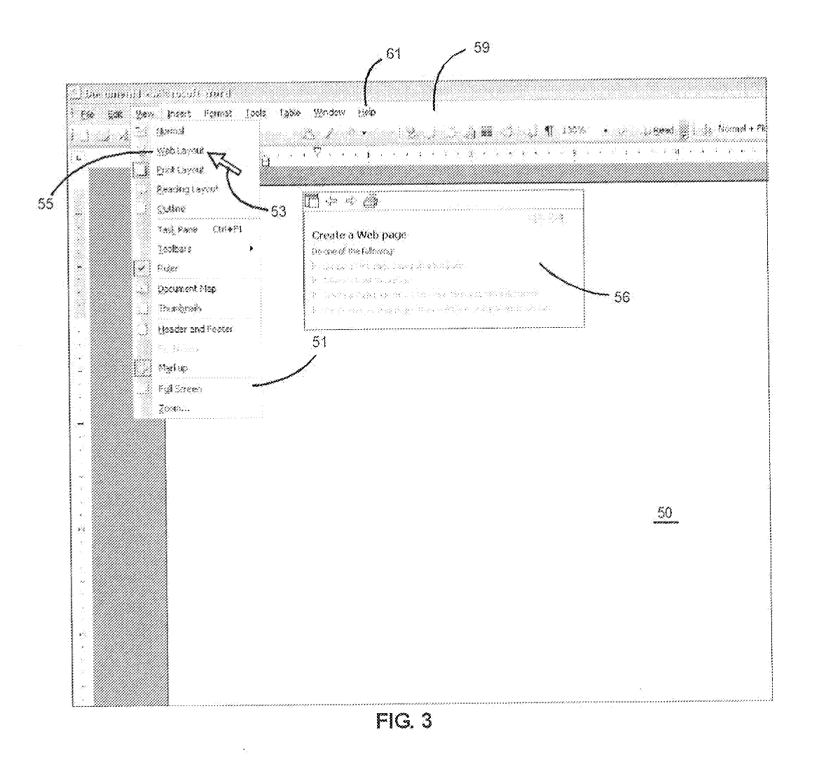

FIG. 3 is an illustration, similar to FIG. 2, wherein the user has selected item 55, Web Layout, in menu 51 via cursor 53. The automatic search in the operating system Help database has not located the exact term. Thus, there is presented in help window 56, help on the approximated closest term, “Create a Web Page”. From this starting window, the user may through appropriate selection of links to access needed help data.

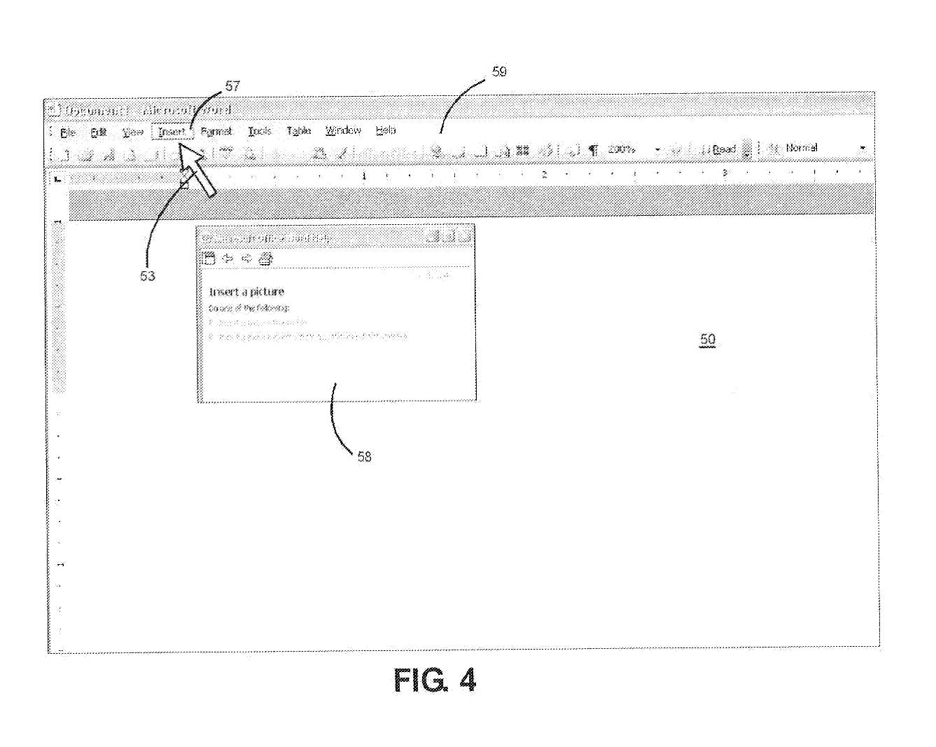

FIG. 4 illustrates a help function similar to that of FIGS. 2 and 3 except that menu item 57 “Insert” selected through cursor 53 is an item on tool bar 59, which is itself a menu, to generate window 58 of the closest Help function, “Insert a picture”.

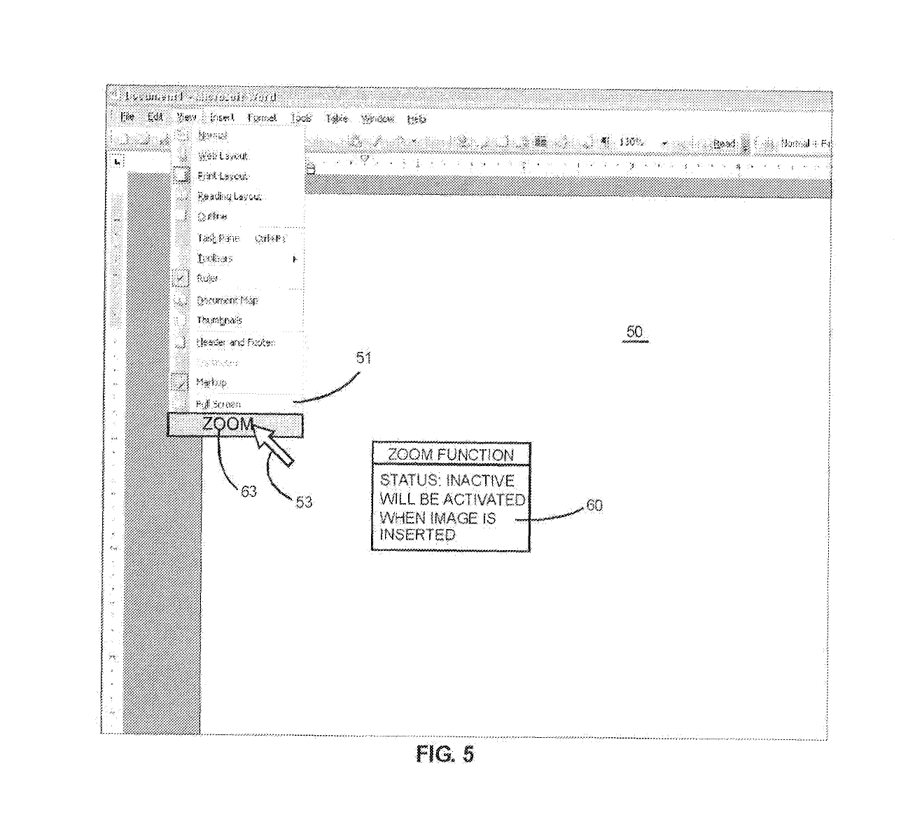

FIG. 5 illustrates another aspect of the present invention. On every displayed menu, there is often one or two items that are “grayed out”, e.g., “Zoom” item 63 which indicates that the item is disabled. Such a disabled function causes confusion to a user who may need to use the function. The invention provides for determining why the disable function is on with respect to the item selected via cursor 53, and provides a help window 60 advising the user how the function represented by item 63 may be enabled.

Referring now to FIG. 6, a typical data processing system is shown that may function as the computer controlled display terminal used in implementing the system of the present invention to directly present contextual help data relative to a selectable menu item for which a user requires help. A central processing unit (CPU) 10, such as any PC microprocessor in a PC available from International Business Machines Corporation (IBM), Lenovo Corporation or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's WindowsXP™ or WindowsNT™, as well as UNIX or IBM's AIX operating systems. Application programs 40 running on the data processing system run in conjunction with operating system 41 and provide output calls to the operating system 41, which in turn implements the various functions to be performed by the application 40. The programs and routines of the present invention to directly present contextual help data relative to a selectable menu item for which a user requires help, to be subsequently described in greater detail, are among these application programs. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components such as a digital to analog converter (not shown) and the like. By using the aforementioned mouse or related devices, a user is capable of inputting information to the system through the keyboard 24 or mouse 26 and receiving output information from the system via display 38.

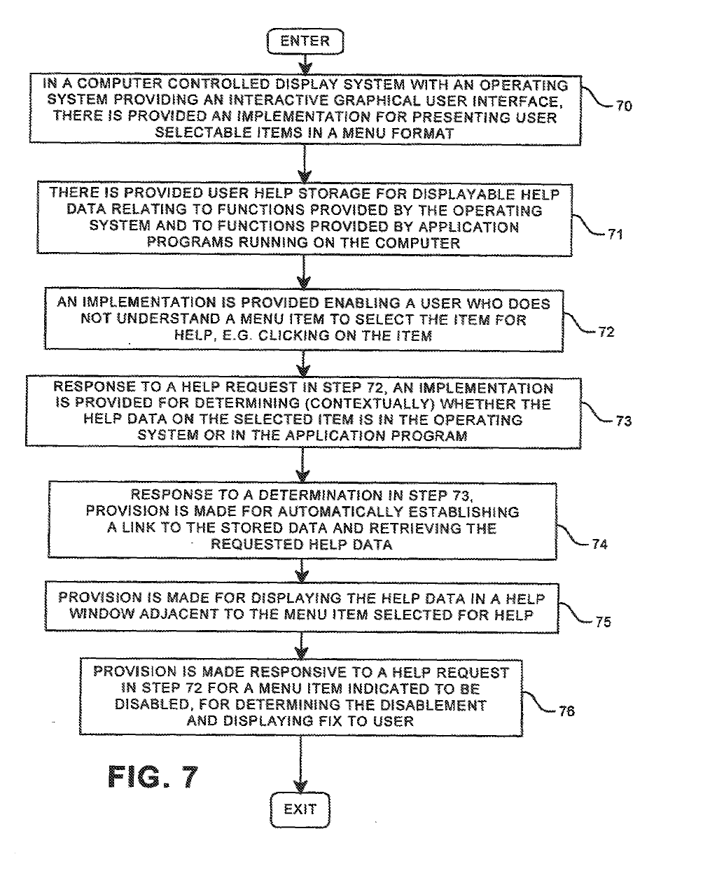

Now, with reference to FIG. 7, there will be described a process implemented by a program according to the present invention for directly presenting contextual help data relative to a selectable menu item for which a user requires help. Programming is provided for a computer controlled display system during the running of application programs to provide a graphical user interface with menus for presenting user selectable items in menus, step 70. Stored help is provided for displaying in a graphical interface, help data related to functions provided by the operating system and by application programs running on the computer operating system, step 71. An implementation is provided to enable a user who does not understand a menu item to select the item for help, e.g. by any particular mouse combination, such as double right click, step 72. Responsive to a help request in step 72, an implementation is provided for determining whether the help data for the selected item is on the operating system or in the application program, step 73.

Responsive to a determination in step 73, provision is made for automatically establishing a link to the stored help data and retrieving the requested help data, step 74. In effect, the process automatically goes to conventional look-up tables in the appropriate help database, and tracks the requested help item as a term to find the closest terms in the Help database much the same as would be searched for if the user had conventionally selected the Help button on a tool bar and entered the name of the menu item. Provision is made, step 75, for displaying the generated help data in a window adjacent to the menu item. This help window gives the user a start from which the user may proceed through a Help data hierarchy in any conventional manner through the selection of appropriate links in the Help window or sequences of links therefrom.

Further provision is made, step 76, responsive to a help request in step 72 where the menu item is disabled, for determining the reason for the disable, and advising the user of the status in the window. Where appropriate, the data in the help window will advise the user how the menu item may be enabled. Very often status data alone will be sufficient. For example, common or general menus such as the “Edit” or “File” are used for many sequential screens in an interactive GUI sequence, and informing the user that the menu item is just not operational for a given screen or stage will be sufficient information for the user. However, there may be circumstances where an item is disabled due to an error condition or a condition which is correctable. In such circumstances, routines may be provided, e.g. for reading the “Hold”, determining the correction if possible, and informing the user in the help window.

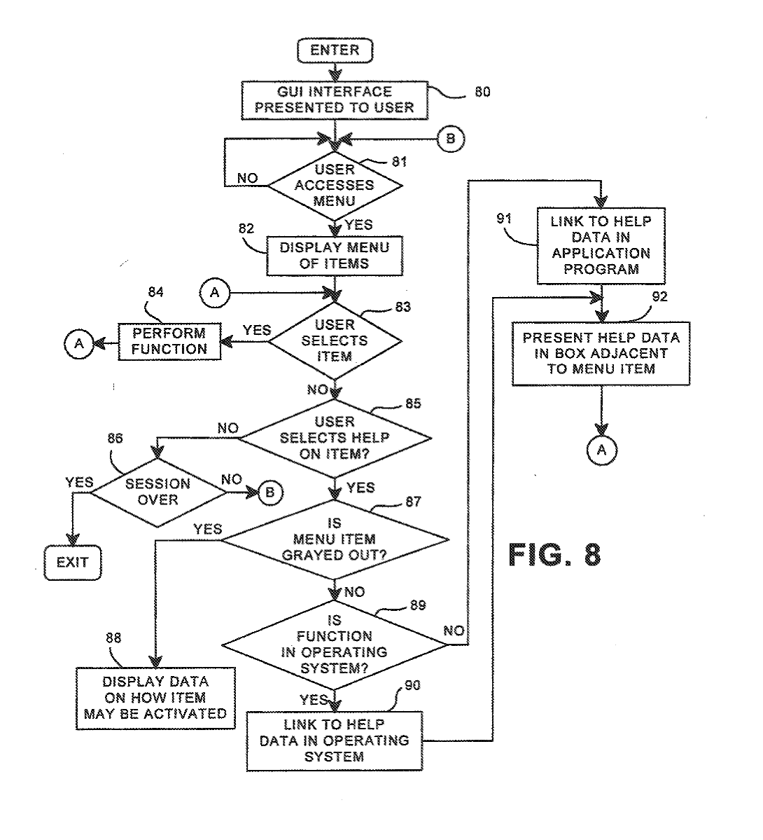

Now that the basic program has been described and illustrated, there will be described with respect to FIG. 8 a flow of a simple operation showing how the program could be run. The GUI interface screen is presented to the user, step 80. A determination is made as to whether the user has accessed a menu, step 81. If Yes, the appropriate menu is displayed, step 82. A determination is made as to whether the user has selected an item to conventionally perform its function, step 83. If Yes, the function is performed, step 84. If No, a further determination is made as to whether the user has selected an item for Help, step 85. If Yes, another determination is made as to whether the item is grayed out to indicate that the help item is disabled, step 87. If Yes, step 88, the status of the disabled item and how the item may be activated are displayed. If the decision in step 87 is No, then help is to be accessed. A determination is first made, step 89, as to whether the function represented by the menu item is the operating system. If Yes, step 90, the process is linked to the Help database for the operating system. If No, step 91, the process is linked to the Help data for the application program being currently run. Then, after either step 90 or 91, the help data is presented in an appropriate GUI window, bubble, or dialog box immediately adjacent to the menu item for which help was requested, step 92.

After either the performance of the menu item function in step 84 or the help display in step 92, the process is returned to step 83 via branch “A”. If there is a No decision in step 85 i.e. No item selection and No item Help selection, a determination may conveniently be made as to whether the session is over, step 86. If Yes, the session is exited. If No, the session is retruded to initial step 81 via branch “B”.

One of the implementations of the present invention may be in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user-interactive display system, a display interface implementation for the presentation of contextual help data comprising:
means for displaying a menu of a plurality of selectable items, each representative of a system function;
means enabling a user to select a menu item to perform the represented function;
means enabling a user to select a menu item for help data for said selected item;
means linking each of said plurality of menu items to a source of contextual help data for each of said menu items; and
means, responsive to said means enabling a user to select a menu item for help, for displaying said contextual help data for said selected menu item.

2. The system of claim 1 wherein said source of contextual help is in the operating system said computer controlled display system.

3. The system of claim 1 wherein said source of contextual help is in an application program running on said computer controlled display system.

4. The system of claim 1 wherein said plurality of selectable items are icons.

5. The system of claim 1 wherein said plurality of selectable items are text items.

6. The system of claim 1 wherein:
said item selected for help is indicated to be disabled; and
said displayed help data discloses how said disabled item may be enabled.

7. The system of claim 6 wherein:
said item selected for help is grayed out to indicate disabled; and said displayed help data is presented in a bubble adjacent to said grayed out item.

8. A method for providing contextual help data in a computer controlled user interactive display interface comprising:
displaying a menu of a plurality of selectable items, each representative of a system function;
enabling a user to select a menu item to perform the represented function;
enabling a user to select a menu item for help data for said selected item;
linking each of said plurality of menu items to a source of contextual help data for each of said menu items; and
displaying said contextual help data for a menu item selected for help responsive to a selection of said menu item.

9. The method of claim 8 wherein said source of contextual help is in the operating system said computer controlled display system.

10. The method of claim 8 wherein said source of contextual help is in an application program running on said computer controlled display system.

11. The method of claim 8 wherein said plurality of selectable items are icons.

12. The method of claim 8 wherein said plurality of selectable items are text items.

13. The method of claim 8 further including the steps of:
indicating that said item selected for help is disabled; and
displaying help data disclosing how said disabled item may be enabled.

14. The method of claim 13 wherein:
said item selected for help is grayed out to indicate disabled; and said displayed help data is presented in a bubble adjacent to said grayed out item.

15. A computer program having program code included on a computer readable medium for providing contextual help data in a user interactive display interface comprising:
means for displaying a menu of a plurality of selectable items, each representative of a system function;
means enabling a user to select a menu item to perform the represented function;
means enabling a user to select a menu item for help data for said selected item;
means linking each of said plurality of menu items to a source of contextual help data for each of said menu items; and
means, responsive to said means enabling a user to select a menu item for help, for displaying said contextual help data for said selected menu item.

16. The computer program of claim 15 wherein said source of contextual help is in the operating system said computer controlled display system.

17. The computer program of claim 15 wherein said source of contextual help is in an application program running on said computer controlled display system.

18. The computer program of claim 15 wherein said plurality of selectable items are icons.

19. The computer program of claim 15 wherein said plurality of selectable items are text items.

20. The computer program of claim 15 wherein:
said item selected for help is indicated to be disabled; and
said displayed help data discloses how said disabled item may be enabled.

21. A method for providing contextual help data in a computer controlled user interactive display interface comprising:
displaying a menu of a plurality of selectable items, each representative of a system function;
enabling a user to select a menu item to perform the represented function;
enabling a user to select a menu item for help data for said selected item;
determining if said menu item selected for help is disabled;
if said menu item selected for help is disabled, displaying help data disclosing how said disabled item may be enabled; and
if said menu item selected for help is not disabled,
displaying contextual help data for said selected menu item.
